(19) United States
(12) Patent Application Publication
(10) Pub. No.: US 2026/0278433 A1
(43) Pub. Date: Sep. 17, 2026

(54) OPEN QUANTUM SYSTEM EXPLORATION THROUGH REINFORCEMENT LEARNING

(71) Applicant: International Business Machines Corporation, Armonk, NY (US)

(72) Inventors: ABHIJIT MITRA, THE WOODLANDS, TX (US); VAIBHAW KUMAR, Frederick, MD (US); Kavitha Hassan Yogaraj, Bangalore (IN)

(21) Appl. No.: 19/012,228

(22) Filed: Jan. 7, 2025

(51) Int. Cl. G06N 10/20

(52) U.S. Cl. CPC G06N 10/20

(57) ABSTRACT

Techniques for open quantum system exploration are described. For example, a computer-implemented method can comprise accessing, by a system operatively coupled to a processor, a digital model of an open quantum system comprising a quantum circuit having a defined gate configuration and configured to evolve from an initial state to a target state as a function of one or more defined gate operations, wherein the open quantum system is governed by a Lindblad model. The method further comprises simulating, by the system, dynamics of the open quantum system using a reinforcement learning process performed on the digital model, the dynamics corresponding to interactions between the open quantum system and an environment; and determining, by the system, one or more terms of a representation of the Lindblad model applicable to the open quantum system based on a result of the reinforcement learning process.

### BACKGROUND

The subject disclosure relates to quantum computing and, more specifically, to open quantum system exploration through reinforcement learning.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable open quantum system exploration through reinforcement learning are discussed.

According to an embodiment, a system is provided. The system can comprise a memory that can store computer executable components. The system can further comprise a processor that can execute the computer executable components stored in the memory, where the computer executable components can comprise a modeling component and a simulation component. The modeling component obtains a digital model of an open quantum system comprising a quantum circuit having a defined gate configuration and configured to evolve from an initial state to a target state as a function of one or more defined gate operations, wherein the open quantum system is governed by a Lindblad model. The simulation component simulates dynamics of the open quantum system using a reinforcement learning process performed on the digital model, the dynamics corresponding to interactions between the open quantum system and an environment, and determines one or more terms of a representation of the Lindblad model applicable to the open quantum system based on a result of the reinforcement learning process.

In one or more implementations, the dynamics correspond to Markovian dynamics and wherein the one or more terms comprise one or more Markovian terms. Additionally, or alternatively, the dynamics correspond to non-Markovian dynamics and wherein the one or more terms comprise one or more non-Markovian terms.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can enable open quantum system exploration through reinforcement learning in accordance with one or more embodiments described herein.

FIG. 2 illustrates an example digital quantum circuit model in accordance with one or more embodiments described herein.

FIG. 3 illustrates a flow diagram of an example, non-limiting method for open quantum system exploration through reinforcement learning in accordance with one or more embodiments described herein.

FIG. 4 illustrates an example reinforcement learning model that can be used for open quantum system exploration in accordance with one or more embodiments described herein.

FIG. 5 illustrates an example digital quantum circuit model configured to transition from a first state to a second state in accordance with one or more embodiments.

FIG. 6 illustrates a flow diagram of an example, non-limiting method for creating a digital quantum circuit in accordance with one or more embodiments described herein.

FIG. 7 illustrates a flow diagram of an example, non-limiting method for determining one or more terms of a representation of the Lindblad model applicable to an open quantum system comprising a quantum circuit, in accordance with one or more embodiments described herein.

FIG. 8 illustrates a flow diagram of another example, non-limiting method for determining one or more terms of a representation of the Lindblad model applicable to an open quantum system comprising a quantum circuit, in accordance with one or more embodiments described herein.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

The exploration of open quantum systems is of paramount importance for simulating many natural phenomena and understanding the proper physics behind those phenomena, as well as for realistic quantum computing. A quantum open system refers to a quantum system that interacts with its surrounding environment. This interaction with the environment results in the loss of quantum coherence (decoherence or phase damping), energy exchange (dissipation or amplitude damping), and other effects that cannot be fully described using the Schrödinger equation for a closed system. In reality, every quantum system is subject to dissipative forces (amplitude damping) and decoherence (phase damping), as complete environmental isolation of quantum systems is only theoretically envisioned. For example, just like any quantum system interacting with its environment, quantum computers are susceptible to decoherence and noise, which degrade the quantum information, even when isolated using vacuum chambers, cryogenic cooling, or other isolation techniques. This is why quantum computers require error correction and isolation to maintain coherence.

The effects attributed to interaction between a quantum system and its environment can be categorized into Markovian dynamics and non-Markovian dynamics. A Markovian process is a stochastic process that satisfies the Markov property, meaning that the future state of the process depends only on the present state and not on its past history. In other words, the process has no memory of how it arrived at its current state. As applied to an open quantum system, the Markovian effects correspond to effects the quantum system has on its environment (e.g., system to environment interaction with no memory effect). For a non-Markovian process on the other hand, the future of the process depends on both the present state and some information about the past, indicating memory effects. As applied to an open quantum system, the non-Markovian effects correspond to the effects the environment has on the system, or information backflow from the environment to the system with no memory effect.

Developed following the Schrödinger equation, the primary equation of quantum mechanics is a general framework used to describe the time evolution of the state (represented by the density matrix (p)) of a quantum system, particularly when the system interacts with an environment (i.e., an open quantum system). For open systems where the environment's effects are memoryless (Markovian), the dynamics are often described by the Lindblad primary equation, which includes terms added to Schrödinger equation, referred to as the Lindblad operators or jump operators, which model specific types of interactions with the environment, such as decay or dephasing. For non-Markovian systems, where the environment retains memory of past interactions, more complex primary equations are needed. These involve additional terms added to the Lindblad equation to account for memory effects.

The primary equation thus provides a complete description of how the state of an open quantum system evolves over time under realistic conditions. This information is critical in understanding, designing, and controlling quantum systems for a variety of scientific and technological applications. Thus, solving the primary equation for an open quantum system is of paramount importance for understanding and harnessing the behavior of quantum systems in realistic environments. Unfortunately, this task is particularly challenging due to the complexity introduced by the interaction between the quantum system of interest and its environment. Analytical solutions to the primary equation exist only for a limited number of simple cases (e.g., two-level quantum systems with specific dissipation models).

With this context in mind, the disclosed subject matter provides techniques for modeling an open quantum system in accordance with a primary equation that accounts for the Markovian dynamics and/or the non-Markovian dynamics of the open quantum system, and further solving the primary equation for the open quantum system to automatically derive the terms thereof using a reinforcement learning process. In one or more embodiments, the open quantum system includes or corresponds to a quantum circuit configured to operate on real hardware (e.g., a real quantum circuit comprising real cubits and coupled to a real quantum processor) with noise attributed to its environment (e.g., a cryogenic environment and other real environments). With these embodiments, solving the primary equation with respect to the Markovian and Non-Markovian terms for the open quantum system corresponds to determining how environmental interactions effects the state of the quantum system over time, including effects on control over qubit coherence and gate performance of the quantum circuit. Accordingly, solving the primary equation for a defined open quantum system comprising a quantum circuit enables one to accurately configure or control operations (e.g., gate operations) of the quantum circuit to achieve a desired output while accounting for environmental effects.

According to an embodiment, a system is provided. The system can comprise a memory that can store computer executable components. The system can further comprise a processor that can execute the computer executable components stored in the memory, where the computer executable components can comprise a modeling component and a simulation component. The modeling component obtains a digital model of an open quantum system comprising a quantum circuit having a defined gate configuration and configured to evolve from an initial state to a target state as a function of one or more defined gate operations, wherein the open quantum system is governed by a Lindblad model. The simulation component simulates dynamics of the open quantum system using a reinforcement learning process performed on the digital model, the dynamics corresponding to interactions between the open quantum system and an environment. The simulation component further determines one or more terms of a representation of a Lindblad model applicable to the open quantum system based on a result of the reinforcement learning process.

In one or more implementations, the dynamics correspond to Markovian dynamics and the one or more terms comprise one or more Markovian terms. Additionally, or alternatively, the dynamics correspond to non-Markovian dynamics and the one or more terms comprise one or more non-Markovian terms.

In one or more embodiments, the reinforcement learning process comprises training an actor-critic reinforcement learning model to learn the one or more terms.

In various embodiments, the (digital) quantum circuit is configured to operate on real hardware with noise, and wherein the one or more terms correspond to noise processes in the quantum system attributed to the noise.

In various embodiments, the target state comprises a mixed state and wherein the initial state comprises a mixed state.

In some embodiments, the modeling component generates the digital model of the quantum circuit configured to evolve from the initial state to the target state via the one or more gate operations using the reinforcement learning process (or an alternative reinforcement learning process). With these embodiments, the modeling component determines the one or more gate operations that result in the quantum circuit evolving from the initial state to the target state using the reinforcement learning process (or the alternative reinforcement learning process). In this regard, the reinforcement learning process (or the alternative reinforcement learning process) can comprise performing gate operations on the quantum circuit and tailoring the gate operations based on a fidelity between the target state and an intermediate state of the quantum circuit following the gate operations. The reinforcement learning process (or the alternative reinforcement learning process) can further comprise rewarding respective gate operations that result in increasing the fidelity, wherein the rewarding comprises associating a reward with the respective gate operations, and progressively increasing the reward as the fidelity increases.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

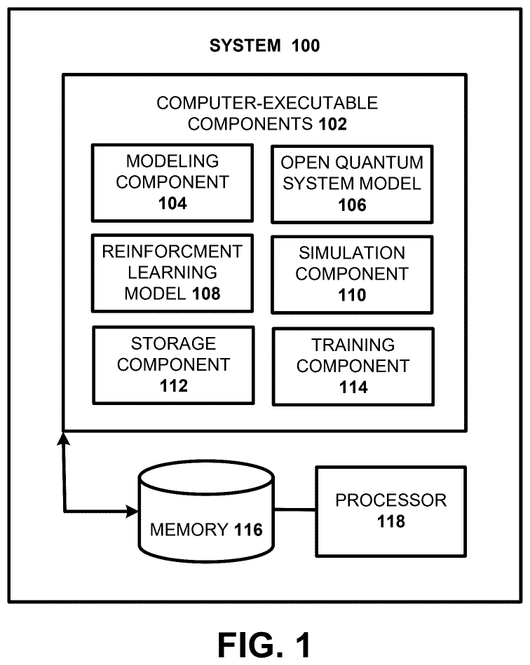

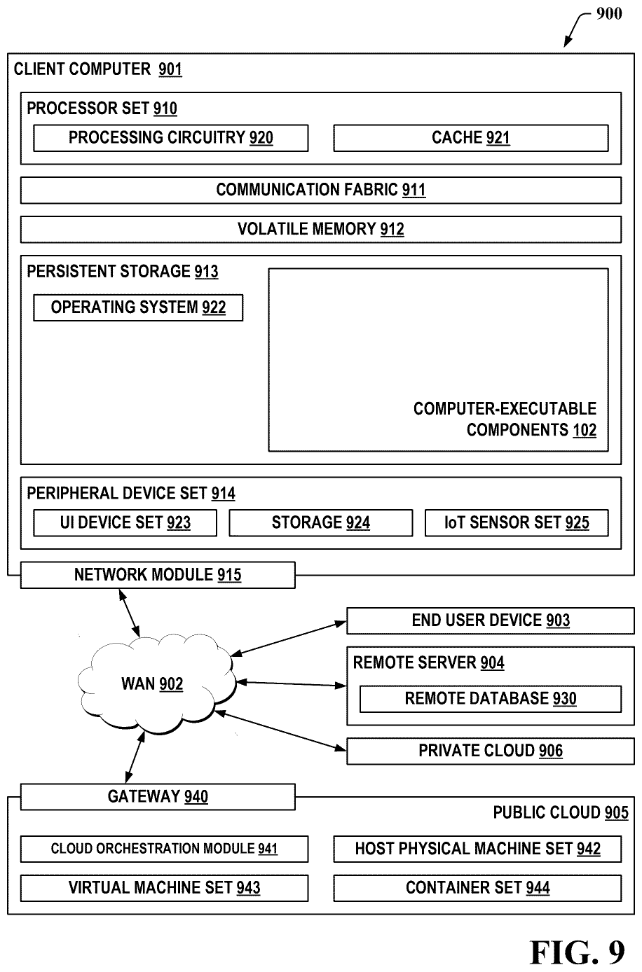

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 900 illustrated at FIG. 9. For example, non-limiting system 100 can be associated with, such as accessible via, a operating environment 900 described below with reference to FIG. 9, such that aspects of processing can be distributed between non-limiting system 100 and the operating environment 900. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that that can enable open quantum system exploration through reinforcement learning in accordance with one or more embodiments described herein. According to various embodiments, non-limiting system 100 can be implemented as a computer-implemented method or as a computer program product.

Non-limiting system 100 and/or the components of non-limiting system 100 can be employed to use hardware and/or software to solve problems that are highly technical in nature (e.g., related to simulating open quantum systems and determining Markovian and non-Markovian dynamics using reinforcement learning, a machine learning process), that are not abstract and that cannot be performed as a set of mental acts by a human. Further, some of the processes performed may be performed by specialized computers for carrying out defined tasks related to open quantum system exploration. Non-limiting system 100 and/or components of the system can be employed to solve new problems that arise through advancements in technologies mentioned above and/or the like. Non-limiting system 100 can provide improvements to quantum computing by simulating open quantum systems and determining Markovian and non-Markovian dynamics using reinforcement learning, a machine learning process. The methods and techniques disclosed in various embodiments herein can enable designing, implementing and controlling open quantum systems comprising quantum circuits with reduced errors attributed to Markovian and non-Markovian effects, which were previously not cable of being accurately or efficiently determined using exiting technology in quantum mechanics.

As illustrated in FIG. 1, non-limiting system 100 can comprise processor 118 (e.g., computer processing unit, microprocessor, classical processor, a quantum processor and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 118 to enable performance of one or more processes defined by such component(s) and/or instruction(s).

In one or more embodiments, non-limiting system 100 can comprise a computer-readable memory (e.g., memory 116) that can be operably connected to processor 118. Memory 116 can store computer-executable components 102 that, upon execution by processor 118, can cause processor 118 to perform one or more actions described with respect to the computer-executable components 102. The computer-executable components 102 can include (but are not limited to), modeling component 104, open quantum system model 106, reinforcement learning model 108, simulation component 110, storage component 112, and training component 114.

Non-limiting system 100 and/or a component thereof as described herein, can be communicatively, electrically, operatively, optically and/or otherwise coupled to one another via any suitable bus. For example, the bus can include one or more of a memory bus, memory controller, peripheral bus, external bus, local bus, and/or another type of bus that can employ one or more bus architectures. In one or more embodiments, non-limiting system 100 can be coupled (e.g., communicatively, electrically, operatively, optically and/or like function) to one or more external systems, sources and/or devices, such as via a network. In one or more embodiments, one or more of the components of non-limiting system 100 can reside in the cloud, and/or can reside locally in a local operating environment (e.g., at a specified location(s)).

In various embodiments, modeling component 104 can access, obtain or generate an open quantum system model 106. Open quantum system model 106 corresponds to a digital or computer model of an open quantum system. In various embodiments, the open quantum system comprises a quantum circuit. With these embodiments, the open quantum system model 106 can include or correspond to a digital quantum circuit model.

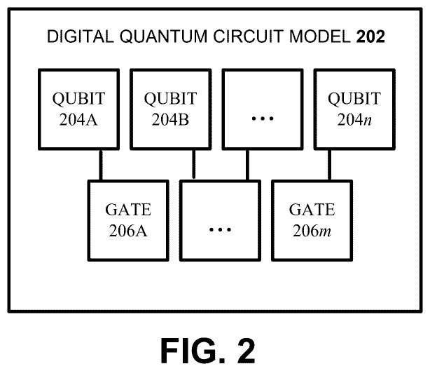

For example, with reference briefly to FIG. 2, FIG. 2 illustrates an example digital quantum circuit model 202 in accordance with one or more embodiments described herein. With reference to FIGS. 1 and 2, in various embodiments, open quantum system model 106 can include or correspond to digital quantum circuit model 202.

A quantum circuit is a sequence of quantum gates applied to qubits (quantum bits). It represents the operations (i.e., control operations) used to perform on a quantum computer to solve a problem. In classical computing, logic gates process bits; in quantum computing, quantum gates manipulate qubits through defined gate operations using the principles of quantum mechanics. Quantum gates can be classified into various types based on their functionality, number of qubits they act upon, and their role in quantum computations. Single-qubit gates manage individual qubit states, while multi-qubit gates manipulate the states of two or more qubits, allowing for interaction and entanglement, crucial for quantum computation.

For example, common single-qubit gates include the Identity gate (I) that leaves the qubit state unchanged, Pauli gates (including an X gate which flips the state from |0> to |1>), a Y gate which combines flipping and phase rotation, and a Z gate which as a phase of −1 to |1>), the Hadamard (H) gate which creates superposition, phase gates (including the S gate that adds a phase of i to |1>, and the T gate which adds a phase of e^{iπ/4} to |1>), and rotational gates (e.g., Rx, Ry, and Rz, which respectively rotate the qubit around the X, Y or Z-axis). Common multi-qubit gates include the controlled not (CNOT) gate which flips the target qubit if the control qubit is in state |1>, the controlled-Z (CZ) gate which ads a phase of −1 when both qubits are |1>, SWAP gates which exchanges the states of two qubit, the CCNOT (or Toffoli) gate which is a 3-qubit gate where the target qubit is flipped if both control qubits are in state |1>, and controlled-phase gates. Quantum gates also include parameterized gates with tunable parameters like rotation angles which enable flexible quantum operations tailored to specific algorithms. Various other quantum gates exist and are being developed to manipulate qubit states.

In a quantum circuit, different quantum gates are combined to control qubits by chaining operations to implement quantum algorithms or perform specific quantum tasks. The combination of gates allows precise manipulation of quantum states, enabling both single-qubit and multi-qubit interactions. For example, Quantum gates are applied in a specific order or sequence to qubits, with the output state of one gate serving as the input for the next. In addition, multiple gates can operate simultaneously on different qubits within a quantum register, enabling parallel processing and more efficient circuit designs. In this regard, by combining select quantum gates in specific sequences and configurations, quantum circuits can perform complex computations. The modular nature of quantum gates, along with universal gate sets, enables the construction of any desired quantum operation, forming the foundation of quantum algorithm design.

In various embodiments, the digital quantum circuit model 202 can include or correspond to a preconfigured quantum circuit model with a defined number of n of qubits 204, (e.g., qubit 204A, qubit 204B, etc.) and a defined number m and sequence of quantum gates 206 (e.g., gate 206A, and so on) configured to perform defined gate operations that result in the quantum circuit evolving form an initial state to a target state. The number n of qubits, the number m of gates, the type of gates, the sequence of gates, and the gate operations performed by the respective gates can vary. The initial state and the target state can also vary. In preferred embodiments, to facilitate evaluating the Markovian and non-Markovian dynamics, the initial state and the target state can respectively correspond to mixed states. However, in other embodiments, the initial state and/or the target state may correspond to a pure state.

Apure state represents a quantum system in a definite, well-defined quantum state. It is described by a single wavefunction or state vector |ψ [symbol] in a Hilbert space. The density matrix ρ of a pure state is defined as ρ=|ψ [symbol] ψ|. A mixed state represents a statistical ensemble of different quantum states, reflecting classical uncertainty about the system's state or entanglement with an environment. The density matrix ρ a mixed state is a probabilistic combination of pure states, defined as ρ=Σᵢpᵢ|ψi [symbol] (ψi|, where pᵢ are the probabilities. In other words, a pure state represents maximal coherence and complete knowledge of the quantum system. A mixed state arises from decoherence, entanglement with an environment, or classical uncertainty. In open quantum systems, a quantum system interacts with its environment, leading to decoherence. This interaction often transforms a pure state into a mixed state.

In various embodiments, environment of the digital quantum circuit model 202 represents an actual deployment environment for the modeled quantum circuit, such as integrated into a real hardware (e.g., a quantum computer comprising a quantum processor) with noise. However, the environment of the digital quantum circuit model can correspond to any defined environment. In various embodiments, digital quantum circuit model 202 is a computer software model that can be used by the simulation component 110 to simulate quantum algorithms applicable to the modeled quantum system.

Various computer tools exist to simulate quantum circuits, which allow user to design and run quantum circuits on classical computers to test and develop quantum algorithms, such as Qiskit™, Cirq™, Intel Quantum Simulator™, and others. Qiskit for example, provides a Python library for constructing digital models of quantum circuits. Qiskit Terra is the foundational component of the Qiskit framework. It provides the essential tools to create, manipulate, and optimize quantum circuits, as well as interface with quantum hardware and simulators. Qiskit Terra allows users to build quantum circuits programmatically using Python. A user can define and manipulate qubits, select and apply quantum gates (e.g., Hadamard, CNOT, Pauli gates, and others), select and define gate operations, and add measurements to create a digital model of a quantum circuit.

Qiskit Aer is a component of Qiskit designed to simulate quantum circuits on classical computers. It allows developers to test, debug, and analyze quantum algorithms without needing access to real quantum hardware. Qiskit Aer uses classical quantum algorithms such as the Lindblad equation and others to mimic quantum behavior, such as superposition, entanglement, and interference. Instead of using actual quantum bits (qubits), it uses mathematical models (like state vectors, density matrices, or stabilizer representations) to represent quantum states and simulate their evolution. A user can create a quantum circuit using Qiskit Terra and pass it to Qiskit Aer for simulation. The simulator then applies the gate operations in the circuit step-by-step to compute the final quantum state or measurement outcomes. Qiskit Aer provides different backend simulators to simulate quantum circuits created using Qiskit Terra, such as but not limited to: Statevector Simulator, which tracks the exact quantum state for small circuits (limited by classical memory); QASM Simulator which simulates measurements and probabilities, mimicking hardware execution; Density Matrix Simulator which tracks mixed quantum states to study noise effects; and Unitary Simulator which computes the overall unitary matrix representing the quantum circuit.

In various embodiments, modeling component 104 can include or correspond to Qiskit Terra or a similar tool for designing quantum circuits and simulation component 110 can include or correspond to Qiskit Aer or a similar tool for simulating quantum circuits on a classical computer (e.g., via processor 118 or the like) once designed. Additionally, or alternatively, system 100 can interface with Qiskit or a similar tool via a network to allow users to create digital quantum circuits and/or run simulations in accordance with the disclosed techniques. In another embodiments, modeling component 104 can access or otherwise obtain (e.g., import) a previously created digital model of a quantum circuit (e.g., using Qiskit Terra or a similar tool) and the simulation component 110 can execute simulations on the quantum circuit.

However, the disclosed techniques are not limited to quantum circuits. In this regard, the open quantum system model 106 can correspond to a digital model of any type of open quantum system. Some additional examples of other open quantum systems that can be modeled and simulated with mathematical software models include but are not limited to, small molecules, condensed matter systems, quantum optics systems, many-body quantum systems, and others.

In accordance with the techniques described herein, the simulation component 110 can employ a reinforcement learning process (e.g., provided by the reinforcement learning model 108, simulation component 110 and training component 114) in association with simulating execution of an open quantum system model 106 to learn and define the terms of a primary equation applicable to open quantum system model 106. More particularly, as the disclosed techniques are concerned with open quantum systems, the applicable mater equation can include or correspond to the Lindblad equation (also referred to as the Markovian primary equation) which accounts for Markovian dynamics (e.g., system to environment dynamics) of the open quantum system model 106. Additionally, or alternatively, the applicable primary equation can include or correspond to a modified version of the Lindblad equation that further accounts for non-Markovian effects.

In this regard, for Markovian dynamics, the primary equation can take the Lindblad form (i.e., Equation 1), where ρ is the system's density matrix, H is the Hamiltonian, and Lₖ are Lindblad operators describing dissipation and decoherence.

$$\begin{matrix}( Lindblad Equation ) . & \\ \frac{d ρ}{d t} = - i [ H , ρ ] + {\sum }_{k} ( {L}_{k} ρ {L}_{k}^{†} - \frac{1}{2} \{ {L}_{k}^{†} {L}_{k} , ρ \} ) , & Equation l\end{matrix}$$

The Lindblad operators Lₖ represent capture a particular type of interaction or process such as energy relaxation or decay, dephasing, absorption and other more complex processes such as transfer, particle loss, and gain in an open quantum system. For example, as applied to a two-level quantum system with states |0> and |1>, the Lindblad operator Lₖ can correspond to \sqrt{γ}σ-, which models spontaneous emission, and/or \sqrt{γ}σ_{z}, which models dephasing or loss coherence.

Non-Markovian dynamics are modeled into the Lindblad primary equation by incorporating memory effects, which means the quantum system's evolution depends on its past states, not just its current state. The non-Markovian dynamics can be accounted for via different approaches, including integrating time-dependent coefficients, integral terms, or other non-local features. As used herein, reference to a modified Lindblad equation refers to the Lindblad equation as modified to include one or more terms that account for the non-Markovian dynamics. For example, in some embodiments, an integro-differential equation can be incorporated into the Lindblad equation to model the system's evolution as an integral over its history. With these embodiments, the modified Lindblad equation takes the form of Equation 2, where K(t−t′) is the memory kernel, which quantifies how the past states of the system affect the present dynamics, and where ρ(t′) is the quantum system's density matrix at earlier times. The memory kernel K(t−t′) encapsulates the environment's temporal correlations and feedback effect.

$$\begin{matrix}( a modified Lindblad Equation ) . & \\ \frac{d ρ ( t )}{d t} = - i [ H , ρ ( t ) ] + {\int }_{0}^{t} K ( t - {t}^{′} ) ρ ( {t}^{′} ) {dt}^{′} & Equation 2\end{matrix}$$

Non-Markovian effects can also be introduced by making the coefficients of the Lindblad equation explicitly time-dependent. With these embodiments, the modified Lindblad equation takes the form of Equation 3, where γk(t) is the time-dependent decay rates. These rates can become negative temporarily, reflecting a backflow of information from the environment to the system.

$$\begin{matrix}( a modified Lindblad Equation ) . & \\ \frac{d ρ ( t )}{d t} = - i [ H ( t ) , ρ ( t ) ] + {\sum }_{k} {γ}_{k} ( t ) 𝒟 [ {L}_{k} ] ρ ( t ) \\ where \\ 𝒟 [ {L}_{k} ] ρ = {L}_{k} ρ {L}_{k}^{†} - \frac{1}{2} \{ {L}_{k}^{†} {L}_{k} , ρ \} is the Lindblad dissipator . & Equation 3\end{matrix}$$

In another embodiment, a time-convolutionless (TCL) approach can be used, which avoids explicit memory kernels. With these embodiments, the Lindblad equation is modified in terms of time-local operators in accordance with Equation 4, where L(t) is a time-dependent super-operator capturing non-Markovian effects.

$$\begin{matrix}( a modified Lindblad Equation ) . & \\ \frac{d ρ ( t )}{d t} = ℒ ( t ) ρ ( t ) & Equation 4\end{matrix}$$

This method simplifies calculations but may lose accuracy for systems with long memory effects. Alternatively, the non-Markovian effects can be represented by Equation 5.

$$\dot{ρ} ( t ) = - i [ {H}_{S}^{′} ( t , {t}_{0} ) , ρ ( t ) ] + {\sum }_{i j} \{ {γ}_{i j} ( t , {t}_{0} ) [ 2 {a}_{j} ρ ( t ) {a}_{i}^{†} - {a}_{i}^{†} {a}_{j} ρ ( t ) - ρ ( t ) {a}_{i}^{†} {a}_{j} ] + {\tilde{γ}}_{i j} ( t , {t}_{0} ) [ {a}_{i}^{†} ρ ( t ) {a}_{j} \pm {a}_{j} ρ ( t ) {a}_{i}^{†} ∓ {a}_{i}^{†} {a}_{j} ρ ( t ) - ρ ( t ) {a}_{j} {a}_{i}^{†} ] \} . \qquad Equation 5$$

With these embodiments, Equation 5 can be transformed into Lindblad form in accordance with equation 6.

$$\frac{d ρ ( t )}{d t} = \frac{1}{i} [ {\tilde{H}}_{S} ( t , {t}_{0} ) , ρ ( t ) ] + {\sum }_{i j} {\tilde{γ}}_{ij} ( t , {t}_{0} ) {L}_{{a}_{i}^{†} , {a}_{j}} [ ρ ( t ) ] + {\sum }_{i j} [ 2 {γ}_{i j} ( t , {t}_{0} ) \pm {\tilde{γ}}_{i j} ( t , {t}_{0} ) ] {L}_{{a}_{j ,} {a}_{i}^{†}} [ ρ ( t ) ]$$

where the super-operator

$${L}_{{a}_{i} , {a}_{j}^{†}} [ ρ ( t ) ]$$

is defined as the standard Lindblad operator

$$\begin{matrix}( a modified Lindblad Equation ) . & \\ {L}_{{a}_{i} , {a}_{j}^{†}} [ ρ ( t ) ] ≡ {a}_{i} ρ ( t ) {a}_{j}^{†} - \frac{1}{2} {a}_{j}^{†} {a}_{i} ρ ( t ) - \frac{1}{2} ρ ( t ) {a}_{j}^{†} {a}_{i} . & Equation 6\end{matrix}$$

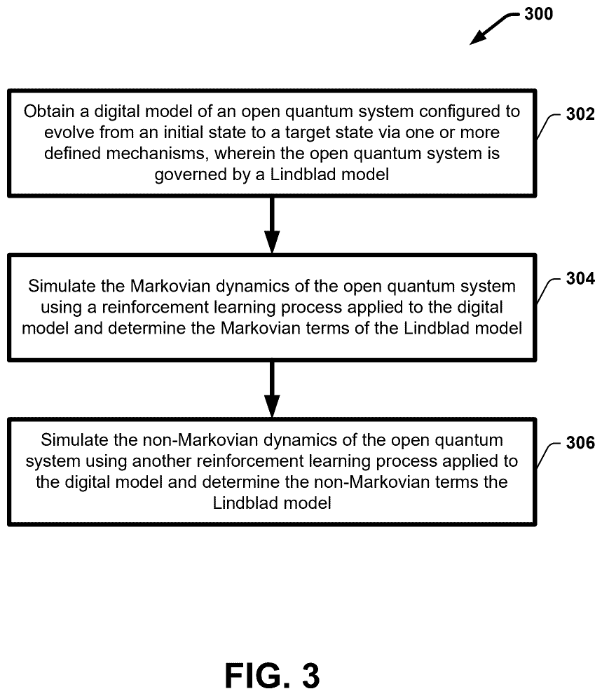

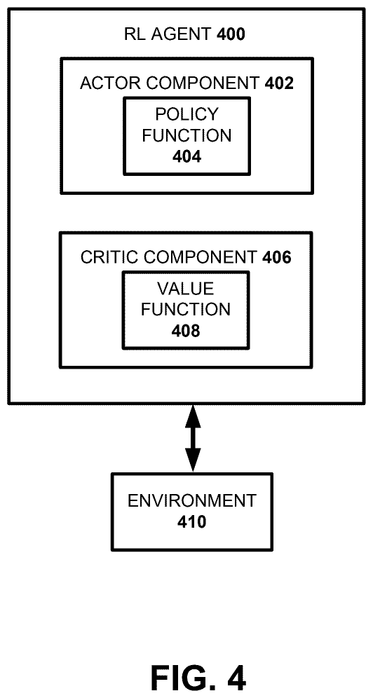

FIG. 3 illustrates a flow diagram of an example, non-limiting method 300 for open quantum system exploration through reinforcement learning in accordance with one or more embodiments described herein. With reference to FIG. 3 in view of FIGS. 1 and 2, method 300 corresponds to a high-level, computer-implemented method (e.g., that can be performed by system 100) in accordance with one or more embodiments. Method 300 comprises, at 302, obtaining (e.g., via modeling component 104) a digital model of an open quantum system (e.g., open quantum system model 106) configured to evolve from an initial state to a target state via one or more defined mechanisms, wherein the open quantum system is governed by a Lindblad model. In this regard, in some embodiments, the digital model can include or correspond to a previously generated and configured model (e.g., generated via modeling component 110 and/or another system using a tool like Qiskit Terra or the like). In other embodiments, the modeling component 104 can facilitate generating the digital model using a reinforcement learning process (an additional reinforcement learning process in addition to those performed at 304 and 306, as described in more detail below with reference to FIG. 4).

The Lindblad model can include or correspond to the Lindblad equation (i.e., Equation 1), or a modified version of the Lindblad equation that includes one or more additional terms which account for non-Markovian effects (e.g., any of Equations 2-6 or another modified form of the Lindblad equation incorporating non-Markovian terms). The type of the open quantum system can vary. In one or more embodiments, the open quantum system comprises a quantum circuit and an environment. For example, in some embodiments, the digital model can correspond to digital quantum circuit model 202.

At 304, method 300 comprises simulating the Markovian dynamics of the open quantum system using a reinforcement learning process applied to the digital model and determining the Markovian terms of the Lindblad Model based on a result of the reinforcement learning process. For example, the Markovian terms can include or correspond to learned measures (e.g., actual values) of the Lindblad operators Lₖ, including a dissipation measure that describes the dissipation of the open quantum system, and a decoherence measure that describes the decoherence or dephasing of the open quantum system.

At 306, method 300 comprises simulating the non-Markovian dynamics of the open quantum system using another reinforcement learning process applied to the digital model and determining the non-Markovian terms of the Lindblad model based on a result of the reinforcement learning process performed at 306. In this regard, in some embodiments, once the Markovian terms have been determined at 304 for the open quantum system as modeled in accordance with Equation 1, the simulation component 110 can apply a modified version of Equation 1 (e.g., any of Equations 2-6 or another modified form of the Lindblad equation incorporating non-Markovian effects) to the open quantum system. The simulation component 110 can further use another reinforcement learning process (e.g., the same or a different type of reinforcement learning process or reinforcement learning model) to learn and define the non-Markovian terms (e.g., time-dependent coefficients, integral terms, or other non-local features). For example, the non-Markovian terms can represent the memory kernel K(t−t′) which quantifies how the past states of the system affect the present dynamics. The non-Markovian terms can also represent γk(t), that is the time-dependent decay rates, and/or L(t) the time-dependent super-operator, and the like.

Reinforcement learning (RL) is a type of machine learning where an agent learns to make decisions by interacting with an environment to maximize a cumulative reward. Unlike supervised learning, where the model is trained on labeled data, in reinforcement learning, the agent explores the environment, takes actions, and receives feedback in the form of rewards or penalties, which it uses to learn the best strategies (policies) over time. In various embodiments, the reinforcement learning processes described herein involve training (e.g., via training component 114) a reinforcement learning model (e.g., reinforcement learning model 108) to learn the Markovian and non-Markovian terms for a given digital model of an open quantum system in association with simulating the Markovian and non-Markovian dynamics of the open quantum system. The type of the reinforcement learning model 108 can vary and include a value-based model, a policy-based model and/or a reinforcement learning model that combines value and policy-based decisions, a type of reinforcement learning model referred to as an actor-critic model.

A policy-based reinforcement learning model is a type of RL approach where the agent directly learns a policy (π) that maps states (s) to actions (a) without the explicit use of a value function. A value-based reinforcement learning model is a type of RL approach where the agent learns a value function that estimates the expected reward of being in a particular state or taking a specific action. The policy (π) which dictates the agent's behavior, is indirectly derived from this value function by selecting actions that maximize the estimated value.

An actor-critic reinforcement learning model is a hybrid approach that combines elements of policy-based and value-based methods. It consists of two key components: an actor that learns and represents the policy that determines the actions to take in a given state; and a critic that learns and estimates the value function which evaluates the quality of the actor's actions. The critic guides the actor by providing feedback on the actions chosen, while the actor updates its' policy to maximize long-term rewards based on the critic's evaluation.

FIG. 4 illustrates an example reinforcement learning model (RL agent 400) that can be used for open quantum system exploration in accordance with one or more embodiments described herein. In accordance with this embodiment, the reinforcement learning model corresponds to an actor-critic model and comprises RL agent 400. With reference to FIG. 1-4, in various embodiments, reinforcement learning model 108 can correspond to RL agent 400. RL agent 400 includes an actor component 402 and a critic component 406. In association with using RL agent 400 to perform a reinforcement learning process, the reinforcement process involves training the RL agent 400 (e.g., via training component 114) to learn a policy that maximizes an expected cumulative return (the reward) in association with performing actions in an environment 410. In accordance with the disclosed techniques, the environment 410 corresponds to open quantum system model 106 and/or digital quantum circuit model 202.

More particularly, the training component 114 initializes the RL agent 400 by defining an initial representation of a policy function 404 employed by the actor component 404 to control its actions in the environment. In this regard, the RL agent 400 interacts with the environment 410, by performing actions of amongst a set of candidate actions that the actor component 402 can make as controlled/defined by the current representation of the policy function 404 policy function. For example, as applied to a digital quantum circuit model 202, the candidate actions can include candidate gate operations (e.g., selection of different quantum gate types, numbers and sequences). Once initialized and activated by the training component 114, the RL agent 400 learns to improve the policy function 404 until convergence is reached or the episode length is reached.

For example, at each iteration of the RL process, the actor component 402 selects an action (aₜ) based on the policy function 404 and applies the action (aₜ) in the environment. The state of the environment then responds to the action by changing to a new state (sₜ) as a result of the action (aₜ).

The critic component 406 evaluates the action by determining a reward (rₜ) as a function of the new state (sₜ) in accordance with a defined value function 408. The reward (rₜ) is a numerical value that the RL agent 400 receives after taking an action in a particular state and indicates how good or bad the action was in achieving the goal. For example, as applied to digital quantum circuit model 202 with the goal of the RL process to learn the gate operations that result in the model evolving from an initial state to a target state, the value function can be configured to provide a positive reward for gate operations (i.e., actions) that move the model closer to the target state and a negative reward for gate operations that move the model farther from the target state. In this regard, the value function 408 can be preconfigured or at least partially preconfigured prior to initiating the RL process.

The critic component 406 also determines an estimated reward (rₑ) for the current state-action pair (e.g., (sₜ), (aₜ)) and computes a temporal difference (TD) error to measure the difference between the critic's prediction (rₑ) and the observed reward (rₜ). The actor component 402 then updates the policy function 404 to increase the likelihood of selecting subsequent actions in subsequent learning iterations that lead to positive rewards. In addition, the critic component 406 updates the value function 408 to minimize the TD error. The actor component 402 then selects another action and continues with the subsequent iteration. The RL agent 400 repeats this process until convergence is reached and/or all possible actions (i.e., the episode length) have been reached.

In accordance with one or more embodiments, modeling component 104 can employ RL agent 400 to obtain or create the digital model of the open quantum system. For example, modeling component 104 can perform an initial reinforcement learning process using RL agent 400 to create the digital quantum circuit model 202. With these embodiments, the goal of the initial reinforcement learning process is to create a digital quantum circuit model (e.g., digital quantum circuit model 202) having a defined number n of qubits, and defined gate operations (e.g., accounting to the number m, type and sequence of quantum gates a defined number, type and sequence of gates) that results in the digital quantum circuit model 202 being configured to evolve from a first state to a second state (via the gate operations), wherein the first state is a mixed state and the second state is a mixed state, and wherein the respective states of the quantum circuit are represented by the density matrix ρ.

To facilitate this end, the modeling component 104 (and/or training component 114) can initialize the digital quantum circuit model 202 in a pure state and perform a first initial reinforcement learning process using RL agent 400 to determine a basis gate configuration (number, type and sequency of gates) for the digital quantum circuit model 202 that results in the quantum circuit transitioning from a pure state to a first target mixed state for an n cubit circuit having a defined number n of cubits (wherein n can vary and include any integer greater than 1). In this scenario, the environment 408 corresponds to an initial representation of the quantum circuit with one or more random gates. The set of actions (aᵢ) that the RL agent 400 can perform (as controlled by the policy function 404) includes selection of candidate gate configurations (e.g., accounting for different numbers, types and sequences of quantum gates), and the state (sᵢ) of the quantum circuit corresponds to its density matrix. The candidate gate configurations can account for a variety of different types of quantum gates, including existing and future developed single-qubit gates, multi-qubit gates, and parameterized gates. The observation space can include or correspond to a data storage array of size 1×2n to store the state vector of the n qubit system after each step (i.e., each action). In various embodiments, the data storage array corresponds to storage component 112 of system 100. In an embodiment, the reward (r), as controlled by the value function 408, can be based on the fidelity between the intermediate state (after application of a candidate gate configuration) and the first target mixed state. In some implementations, the value function 408 can be configured to progressively increases the reward as 1, 10, and 100 for the ranges of fidelities (0.5, 0.9), [0.9, 0.99), [0.99, 1.0] respectively. For all other non-optimal values of the fidelity, the reward can be set to −1.

In other words, given a set of candidate gate configurations (including different numbers and types of gates) and a quantum circuit comprising n number of qubits, the first initial reinforcement learning process generally corresponds to giving the RL agent 400 a set of candidate gate configurations and directing the RL agent 400 to find the optimal gate configuration that achieves the desired result, that is transitioning from the initial pure state to the first target mixed state.

Once the basis gate configuration has been determined using the first initial reinforcement learning process, the modeling component 104 (or the training component 114) can perform a second initial reinforcement learning process on the quantum circuit model as configured as a result of the first initial reinforcement learning process (e.g., with the basis gate configuration). The goal of the second initial reinforcement learning process is to determine a new gate configuration (e.g., a modified version of the basis gate configuration) that results in the quantum circuit transitioning from the first target mixed state to a second target mixed state.

To facilitate this end, the modeling component 104 (or training component 114) can initialize the digital quantum circuit model 202 with the basis gate configuration in the first target mixed state sate and perform the second initial reinforcement learning process using another instance of RL agent 400 (or another type of reinforcement learning model) to determine a modified gate configuration from the basis gate configuration that results in the quantum circuit transitioning from the first target mixed state to the second target mixed state. In this scenario, the initial representation of environment 408 corresponds to the representation of the quantum circuit with the basis gate configuration and the first mixed state. The set of actions (aᵢ) that the RL agent 400 can perform (as controlled by the policy function) includes selection of new candidate gate configurations (e.g., accounting for different numbers, types and sequences of quantum gates), and the state (sᵢ) of the quantum circuit corresponds to its density matrix. The candidate gate configurations can account for a variety of different types of quantum gates, including existing and future developed single-qubit gates, multi-qubit gates, and parameterized gates. The episode length of the second initial reinforcement learning process is defined to be the maximum number of gate operations that can be performed on the circuit in accordance with the basis gate configuration chosen. The candidate gate operations can also include the ‘no gate operation’ as an action, so that if the RL agent 400 learns to create the second target mixed state in fewer steps than that defined by default, it will stop the gate operations there so that the achieved state does not get destroyed. The state (sᵢ) of the quantum circuit corresponds to its density matrix. The observation space can include or correspond to a data storage array of size 1×2n to store the state vector of the n qubit system after each step (i.e., action). In various embodiments, the data storage array corresponds to storage component 112 of system 100. The reward (r) can be based on the fidelity between the intermediate state (after application of candidate gate configuration) and the second target mixed state. In some implementations, the reward progressively increases as 1, 10, and 100 for the ranges of fidelities (0.5, 0.9), [0.9, 0.99), [0.99, 1.0] respectively. For all other non-optimal values of the fidelity, the reward can be set to −1.

The result of the initial (first and second) reinforcement learning processes is a digital quantum circuit model (e.g., digital quantum circuit model 202) having a defined number n of qubits and one or more defined gate operations (e.g., accounting for the number, type and sequence of quantum gates) applicable to the digital quantum circuit model that that results in the quantum circuit model evolving from an initial mixed state to a target mixed state.

The above approach (involving the first and second initial reinforcement learning processes) was implemented using a two-qubit example and a Bell state was successfully learned by the RL agent 400. In accordance with this example implementation, the Bell state corresponds to the second mixed target state. In this example, the basis gate set comprised the H, T, and CX gates on the circuit with two qubits. The training was done using the Proximal Policy Optimization (PPO) algorithm and the actor-critic reinforcement learning model (e.g., RL agent 400 or a similar model). Later, it was extended to a general n qubit case with the H and CX gates as the actions on a circuit starting in the all-zero state and having the GHZ state (for the n qubit system) as the second target mixed state.

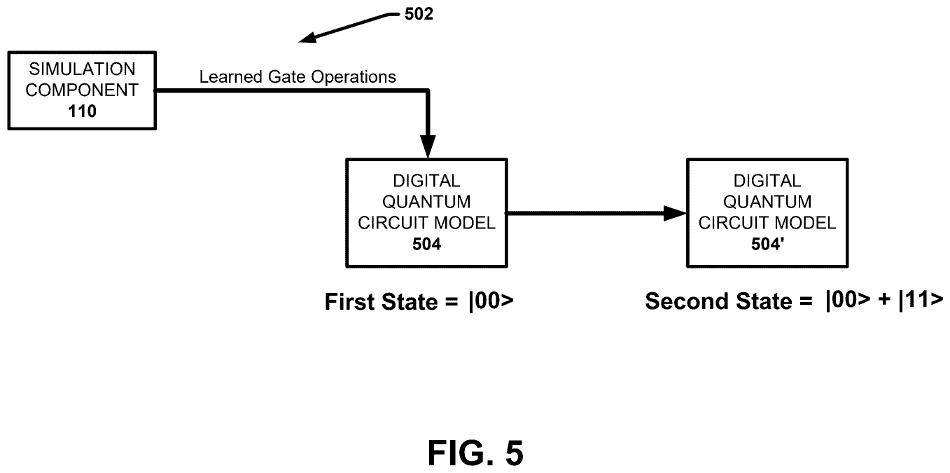

With reference briefly to FIG. 5, FIG. 5 illustrates an example digital quantum circuit model 504 configured to transition from a first state to a second state in accordance with one or more embodiments. In this example, the digital quantum circuit model 504 corresponds to the two-qubit example, wherein to the first state is the all-zero state (a pure state, represented as |00>), and the second state is the Bell state (a mixed state, represented as |00>+11>). In accordance with FIG. 5, the simulation component 110 initialized the digital quantum circuit model 504 in the first state and applies the learned gate operations 502 to the digital quantum circuit model 504 to cause the digital quantum circuit model 504 to evolve into the second state. In this regard, in response to application of one or more learned gate operations (learned using the first and/or second initial reinforcement learning processes described above) to the digital quantum circuit model 504 in the first state and having the basis gate configuration (e.g., via simulation component 110), the digital quantum circuit model 504 evolves into digital quantum circuit model 504′ having the second state as opposed to digital quantum circuit model 504 having the first state.

With reference again to FIG. 4 in view of FIGS. 1-3 and 5, in various embodiments, the representation of the digital quantum circuit model 202 following the first and/or second initial reinforcement learning process only accounts for the unitary evolution of the quantum circuit. In other words, the gate operations (e.g., accounting for the number, types and sequence of quantum gates) are learned assuming the quantum circuit is a closed system that does not interact with an external environment. In this case, the quantum circuit's state evolution is governed entirely by its internal dynamics, which are described by the Schrödinger equation.

To this end, the representation of the digital quantum circuit model 202 following the first and/or second initial reinforcement learning processes corresponds to the digital model obtained at 302 of method 300 by the modeling component 104. In this regard, in association with applying method 300 to digital quantum circuit model 202, once this representation of the quantum circuit is learned, that is a quantum circuit, having a defined number of qubits and a defined gate configuration, and configured to transition from an initial mixed state to a target mixed state via one or more defined gate operations, the simulation component 110 (and the training component 114) can perform step 304, followed by step 306, to determine the Markovian and Non-Markovian terms. With these embodiments, the digital quantum circuit model 202 is evaluated relative to its external environment.

With these embodiments, at 304, simulation component 110 can simulate the Markovian dynamics of the digital quantum circuit model 202 using a (third) reinforcement learning process applied to the digital quantum circuit model 202 to determine the Markovian terms of the Lindblad equation. The (third) reinforcement learning process can correspond to the first and second initial reinforcement learning processes described above, yet tailored to a new goal; that is learning the Markovian terms that define the Markovian dynamics (system to environment) of the digital quantum circuit model 202. In some embodiments, the (third) reinforcement learning process can employ the actor-critic reinforcement learning model (e.g., corresponding to RL agent 400 or a similar model).

In accordance with the (third) reinforcement learning process the digital quantum circuit model 202 again acts as the environment 408, where applying gate operations actions or control signals causes transitions between quantum states of the quantum circuit. The RL agent 400 interacts with this environment to learn the state transitions. The RL agent 400 can learn a policy which maps the current state sᵢ to an action aᵢ to maximize the expected cumulative reward. Instead of directly learning a policy, the RL agent 400 can focus on learning the Markovian dynamics by approximating the transition probability P(s′|s, a) where s′ is the next state. With these embodiments, the reward function can be designed to encourage learning accurate Markovian dynamics or the Markovian terms of the Lindblad model (e.g., Equation 1) that define the Markovian dynamics of the digital quantum circuit model 202. In this regard, Markovian dynamics is where the history can be ignored and everything in the n+1^{th} step comes out the nth. In this case, when the digital quantum circuit model 202 system is getting influenced by the environment, the actor-critic type RL model (e.g., RL agent 400) can. learn the Lindblad operators (e.g., which model specific types of interactions with the environment, such as decay or dephasing). Here, the probability of moving from one state to another does not change over time.

Continuing with method 300, the simulation component 110 can further simulate the non-Markovian dynamics of the digital quantum circuit model 202 using a (fourth) reinforcement learning process applied to the digital quantum circuit model 202 to determine the non-Markovian terms of the Lindblad model. As discussed above, in association with determining the non-Markovian dynamics, the Lindblad model can be modified to include non-Markovian terms (e.g., as represented in Equations 2-6 or the like). In this regard, the (fourth) reinforcement learning process can correspond to the third reinforcement learning process described above, yet tailored to a new goal; that is learning the non-Markovian terms that define the non-Markovian dynamics (environment to system memory back flow) of the digital quantum circuit model 202. In some embodiments, the (fourth) reinforcement learning process can employ the actor-critic reinforcement learning model (e.g., corresponding to RL agent 400 or a similar model).

In accordance with the (fourth) reinforcement learning process the digital quantum circuit model 202 acts as the environment 408, where applying gate operations actions or control signals causes transitions between quantum states of the quantum circuit. The RL agent 400 interacts with this environment to learn the state transitions. The RL agent 400 can learn a policy which maps the current state sᵢ to an action aᵢ to maximize the expected cumulative reward. Instead of directly learning a policy, the RL agent 400 can focus on learning the Markovian dynamics by approximating the transition probability P(s′|s, a) where s′ is the next state. With these embodiments, the reward function can be designed to encourage learning accurate non-Markovian dynamics or the non-Markovian terms that define the non-Markovian dynamics of the digital quantum circuit model 202.

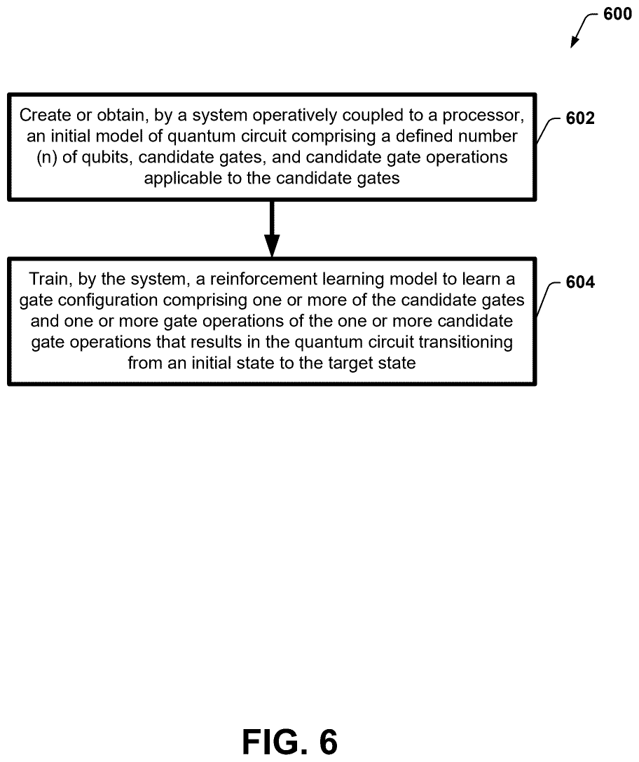

FIG. 6 illustrates a flow diagram of an example, non-limiting method 600 for creating a digital quantum circuit in accordance with one or more embodiments described herein. Method 600 corresponds to an example method that can be performed by system 100. Method 600 comprises, at 602, creating (e.g., via modeling component 104 and/or a quantum circuit modeling application such as Qiskit or the like) or obtaining (as previously created), by a system operatively coupled to a processor (e.g., system 100), an initial model of quantum circuit comprising a defined number (n) of qubits, candidate gates, and candidate gate operations applicable to the candidate gates. At 604, method 600 comprises training, by the system (e.g., via training component 114), a reinforcement learning model (e.g., reinforcement learning model 108, RL agent 400, or the like) to learn a gate configuration comprising one or more of the candidate gates, and one or more gate operations of the one or more candidate gate operations, that results in the quantum circuit transitioning from an initial state to the target state.

In this regard, method 600 combines the first and second initial reinforcement learning processes discussed above. For example, the initial state can correspond to a first mixed state and the target state can correspond to a second mixed state. With these embodiments, the reinforcement learning process can comprise performing gate operations on the quantum circuit (e.g., by the RL agent 400 as directed by the training component 114) and tailoring the gate operations based on a fidelity between the target state and an intermediate state of the quantum circuit following the gate operations. The reinforcement learning process can further comprise rewarding respective gate configuration and/or gate operations that result in increasing the fidelity, wherein the rewarding comprises associating a reward with the respective gate configurations and/or operations, and progressively increasing the reward as the fidelity increases.

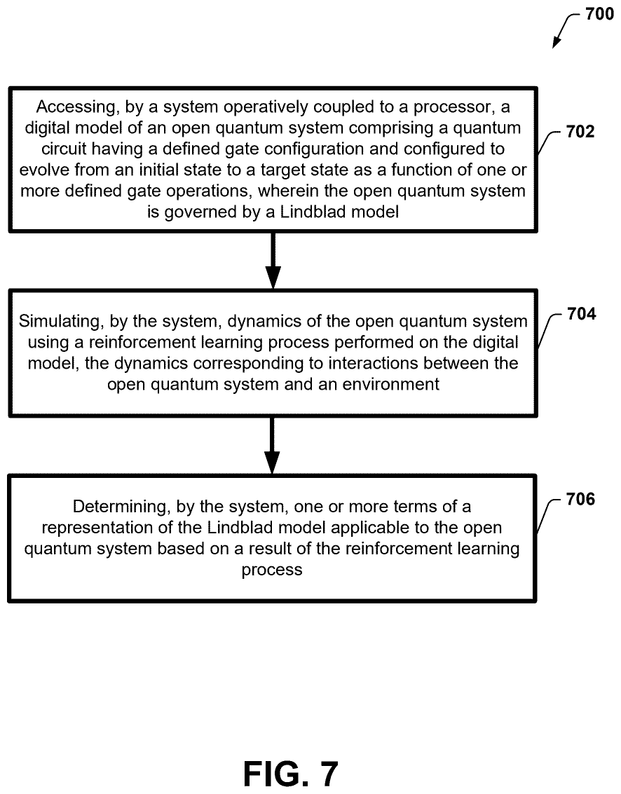

FIG. 7 illustrates a flow diagram of an example, non-limiting method for 700 determining one or more terms of a representation of the Lindblad model applicable to an open quantum system comprising a quantum circuit, in accordance with one or more embodiments described herein. Method 700 corresponds to another example method that can be performed by system 100. Method 700 comprises, at 702, accessing, by a system operatively coupled to a processor, a digital model of an open quantum system comprising a quantum circuit having a defined gate configuration and configured to evolve from an initial state to a target state as a function of one or more defined gate operations, wherein the open quantum system is governed by a Lindblad model. For example, the digital model can correspond to that resulting from method 600. The Lindblad model can include or correspond to any of Equations 1-6 or the like. At 704, method 700 comprises simulating, by the system, dynamics of the open quantum system using a reinforcement learning process performed on the digital model, the dynamics corresponding to interactions between the open quantum system and an environment (e.g., Markovian and/or non-Markovian). At 706, method 600 comprises determining, by the system, one or more terms of a representation of the Lindblad model (e.g., as formulated in accordance with any of Equations 1-6, and with actual values or solutions for the Lindblad operators) applicable to the open quantum system based on a result of the reinforcement learning process.

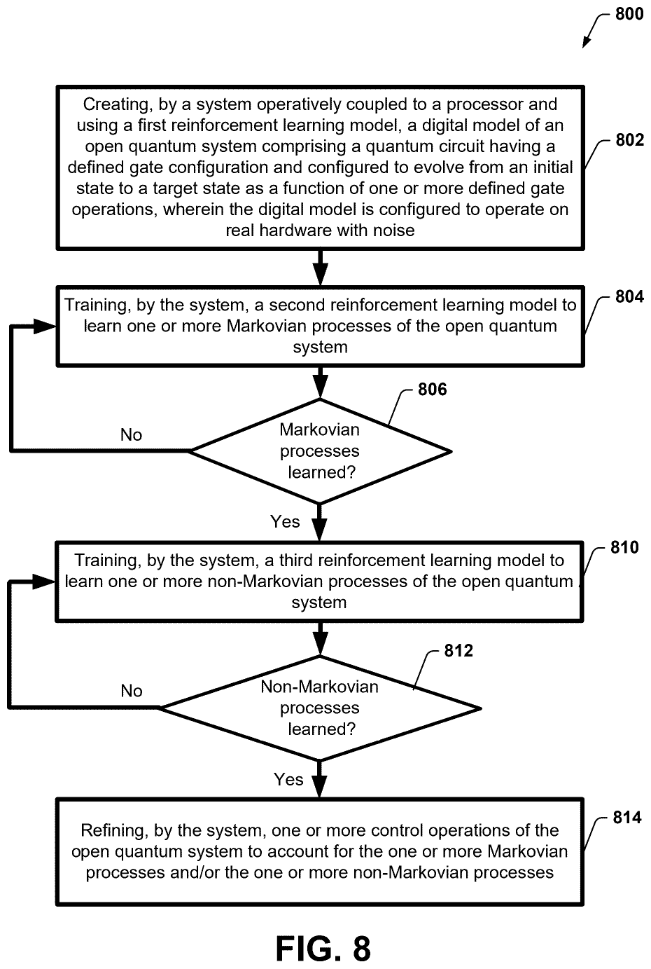

FIG. 8 illustrates a flow diagram of another example, non-limiting method 800 for determining one or more terms of a representation of the Lindblad model applicable to an open quantum system comprising a quantum circuit, in accordance with one or more embodiments described herein. Method 800 corresponds to another example method that can be performed by system 100. Method 800 comprises, at 802, creating (e.g., via modeling component 104), by a system operatively coupled to a processor and using a first reinforcement learning model (e.g., reinforcement learning model 108, RL agent 400, or the like), a digital model of an open quantum system comprising a quantum circuit having a defined gate configuration and configured to evolve from an initial state to a target state as a function of one or more defined gate operations, wherein the digital model is configured to operate on real hardware with noise. At 804, method 800 comprises training, by the system, a second reinforcement model (e.g., a second instance of reinforcement learning model 108, a second instance of RL agent 400, or the like to) to learn one or more Markovian processes of the open quantum system (e.g., via training component 114 and simulation component 110). At 808, the training component determines whether (all target) Markovian processes have been learned by the second reinforcement learning model. If not, method 800 returns to 804 and continues training the second reinforcement learning model. Based on a determination at 808 that (all target) Markovian processes have been learned by the second reinforcement learning model, method 800 continues to 810.

At 810, method 800 comprises training, by the system, a third reinforcement model (e.g., a third instance of reinforcement learning model 108, a third instance of RL agent 400, or the like to) to learn one or more non-Markovian processes of the open quantum system (e.g., via training component 114 and simulation component 110). At 812, the training component determines whether (all target) non-Markovian processes have been learned by the third reinforcement learning model. If not, method 800 returns to 810 and continues training the third reinforcement learning model. Based on a determination at 812 that (all target) non-Markovian processes have been learned by the second reinforcement learning model, method 800 continues to 814. At 814, the system refines one or more control operations of the open quantum system to account for the one or more Markovian processes and/or the one or more non-Markovian processes (e.g., via modeling component 104). For example, as applied to the open quantum system comprising a digital quantum circuit, the one or more control operations that are refined can include or correspond to the gate operations.

In this regard, Markovian dynamics in quantum circuits describe a situation where the system's evolution is memoryless, meaning the state evolution at any given time depends only on the current state, not on its past history. This assumption is common in many quantum computing models and simplifies the treatment of noise and decoherence. Adapting gate operations to account for Markovian dynamics involves incorporating techniques to mitigate errors that arise due to Markovian noise, such as amplitude damping, dephasing, or depolarization. For example, in some implementations, the modeling component 104 can adapt gate operations using pulse shaping. Quantum gates are implemented via controlled pulses. To adapt for Markovian dynamics, the modeling component 104 can finely tune the pulses (e.g., amplitude and duration) to minimize the impact of decoherence and other noise. Additionally, or alternatively, modeling component 104 can calibrate the gate operations to ensure gate fidelities are maximized while compensating for typical Markovian noise sources. Modeling component 104 can also adjust the gate operations using dynamical decoupling, wherein gate sequences are interleaved with additional pulses to counteract decoherence. For instance, Carr-Purcell-Meiboom-Gill (CPMG) sequences can suppress Markovian noise by flipping qubits frequently during idle periods.

Non-Markovian dynamics arise when the system's evolution depends on its history, often due to interactions with an environment that retains memory of past system-environment interactions. Such dynamics deviate from the typical Markovian (memoryless) approximation commonly assumed in quantum circuit modeling. Adapting gate operations to account for non-Markovian effects requires incorporating features that handle memory effects, decoherence, and potential correlations. For example, modeling component 104 can adjust the gate operations to include terms representing memory effects. In another example, modeling component 104 can control the Hamiltonians' of the gates dynamically to counteract or exploit non-Markovian feedback effects.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 9 illustrates a block diagram of an example, non-limiting, operating environment in which one or more embodiments described herein can be facilitated. FIG. 9 and the following discussion are intended to provide a general description of a suitable operating environment 900 in which one or more embodiments described herein at FIGS. 1-8 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Operating environment 900 contains an example of an environment for the execution of at least some of the computer code involved in performing the inventive methods, such as one or more of the computer-executable components 102. In addition, operating environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and computer-executable components 92, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of operating environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some operating environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In operating environment 900, at least some of the instructions for performing the inventive methods may be stored in block 926 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 926 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual operating environments that run on various computers making up the computers of host physical machine set 942, which is the universe of physical computers in and/or available to public cloud 905. The virtual operating environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized operating environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local network. A hybrid cloud is a composition of multiple clouds of different types (for example, internal, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Python, R, Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed operating environments in which tasks are performed by remote processing devices that are linked through a communications network. However, one or more, if not all aspects of the one or more embodiments described herein can be practiced on stand-alone computers. In a distributed operating environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a modeling component that obtains a digital model of an open quantum system comprising a quantum circuit having a defined gate configuration and configured to evolve from an initial state to a target state as a function of one or more defined gate operations, wherein the open quantum system is governed by a Lindblad model; and
a simulation component that simulates dynamics of the open quantum system using a reinforcement learning process performed on the digital model, the dynamics corresponding to interactions between the open quantum system and an environment, and determines one or more terms of a representation of the Lindblad model applicable to the open quantum system based on a result of the reinforcement learning process.

2. The system of claim 1, wherein the dynamics comprise to Markovian dynamics and wherein the one or more terms comprise one or more Markovian terms.

3. The system of claim 1, wherein the dynamics comprise to non-Markovian dynamics and wherein the one or more terms comprise one or more non-Markovian terms.

4. The system of claim 1, wherein the reinforcement learning process comprises training an actor-critic reinforcement learning model to learn the one or more terms.

5. The system of claim 1, wherein the digital model of the quantum circuit is configured to operate on real hardware with noise, and wherein the one or more terms correspond to noise processes in the quantum system attributed to the noise.

6. The system of claim 1, wherein the target state comprises a mixed state and wherein the initial state comprises a mixed state.

7. The system of claim 1, wherein the modeling component generates the digital model of the quantum circuit configured to evolve from the initial state to the target state via the one or more gate operations using the reinforcement learning process or an alternative reinforcement learning process.

8. The system of claim 7, wherein the modeling component determines the one or more gate operations that result in the quantum circuit evolving from the initial state to the target state using the reinforcement learning process or the alternative reinforcement learning process.

9. The system of claim 8, wherein the reinforcement learning process or the alternative reinforcement learning process comprises performing gate operations on the quantum circuit and tailoring the gate operations based on a fidelity between the target state and an intermediate state of the quantum circuit following the gate operations.

10. The system of claim 9, wherein the reinforcement learning process or the alternative reinforcement learning process comprises updating a policy function or a reward function of a reinforcement model employed for the reinforcement learning process to favor selection of respective gate operations that result in increasing the fidelity.

11. A computer-implemented method, comprising:
accessing, by a system operatively coupled to a processor, a digital model of an open quantum system comprising a quantum circuit having a defined gate configuration and configured to evolve from an initial state to a target state as a function of one or more defined gate operations, wherein the open quantum system is governed by a Lindblad model;
simulating, by the system, dynamics of the open quantum system using a reinforcement learning process performed on the digital model, the dynamics corresponding to interactions between the open quantum system and an environment; and
determining, by the system, one or more terms of a representation of the Lindblad model applicable to the open quantum system based on a result of the reinforcement learning process.

12. The method of claim 11, wherein the dynamics comprise Markovian dynamics and wherein the one or more terms comprise one or more Markovian terms.

13. The method of claim 11, wherein the dynamics comprise non-Markovian dynamics and wherein the one or more terms comprise one or more non-Markovian terms.

14. The method of claim 11, wherein the reinforcement learning process comprises training, by the system, an actor-critic reinforcement learning model to learn the one or more terms.

15. The method of claim 11, wherein the digital model of the quantum circuit is configured to operate on real hardware with noise, and wherein the one or more terms correspond to noise processes in the quantum system attributed to the noise.

16. The method of claim 11, wherein the target state comprises a mixed state and wherein the initial state comprises a mixed state.

17. The method of claim 11, further comprising:
generating, by the system, the digital model of the quantum circuit configured to evolve from the initial state to the target state via the one or more gate operations using the reinforcement learning process or an alternative reinforcement learning process.

18. The method of claim 17, wherein the generating comprises determining, by the system, the one or more gate operations that result in the quantum circuit evolving from the initial state to the target state using the reinforcement learning process or the alternative reinforcement learning process, and wherein the reinforcement learning process or the alternative reinforcement learning process comprises performing gate operations on the quantum circuit and tailoring the gate operations based on a fidelity between the target state and an intermediate state of the quantum circuit following the gate operations.

19. A computer program product for quantum circuit design, the computer program product comprising a computer readable storage medium having program instructions embodied therewith, the program instructions executable by a processor to cause the processor to:
access, by the processor, a digital model of an open quantum system comprising a quantum circuit having a defined gate configuration and configured to evolve from an initial state to a target state as a function of one or more defined gate operations, wherein the open quantum system is governed by a Lindblad model;
simulate, by the processor, dynamics of the open quantum system using a reinforcement learning process performed on the digital model, the dynamics corresponding to interactions between the open quantum system and an environment; and
determine, by the system, one or more terms of a representation of the Lindblad model applicable to the open quantum system based on a result of the reinforcement learning process.

20. The computer program product of claim 19, wherein the dynamics comprise Markovian dynamics and non-Markovian dynamics, and wherein the one or more terms comprise one or more Markovian terms and one or more non-Markovian terms.
